(19) United States
(12) Patent Application Publication
(10) Pub. No.: US 2012/0273372 A1
(43) Pub. Date: Nov. 1, 2012

(54) System Including a Bottle for Beverages and a Stand for Supporting the Bottle

(76) Inventors: Tim Goldburt, New York, NY (US); Matt Sandy, New York, NY (US)

(21) Appl. No.: 13/545,640

(22) Filed: Jul. 10, 2012

Related U.S. Application Data
(63) Continuation-in-part of application No. 12/004,427, filed on Dec. 21, 2007, now Pat. No. 8,232,981.

(51) Int. Cl. F21V 33/00; B65D 23/12

(52) U.S. Cl. 206/216

(57) ABSTRACT

A system includes a bottle for beverages with an element having an electronic display displaying video images, and a stand which supports the bottle for beverages and has a light emitting component which emit light controlled by a control for producing lights of different colors.

### CROSS REFERENCE TO RELATED APPLICATION

This application is a continuation -in-part of U.S. patent application Ser. No. 12/004,427 which contains a common subject matter and is incorporated in it by reference.

The above mentioned US patent application forms a basis for a claim to priority under 35 USC 119 (b)-(d),

### BACKGROUND OF THE INVENTION

The present invention relates to systems which include bottles for and/or with beverages, and a stand with supports the bottle.

Systems of the above mentioned general type are know in the art. One of such systems is disclosed in our U.S. patent application Ser. No. 12/004,427. In this patent application the sand not only supports the bottle, but emit light and transmit images from its own display to other stands and/or bottles. The above mentioned system can be further improved for providing new features and functions and introducii interaction of the stand with the bottle.

### SUMMARY OF THE INVENTION

Accordingly, it is an object of the present invention to provide a system including a bottle for beverages and a stand for supporting the bottle , which is a further improvement of existing systems of this type.

In keeping with these objects and with others which will become apparent hereinafter, one feature of the present invention resides, briefly stated, in a system, comprising a bottle for beverages having an element with an electronic display displaying video images; and a stand for supporting said bottle for beverages, said stand having a receptacle which is configured for receiving a part of said bottle for beverages and thereby supporting the latter, said stand also having light emitting means configured to emit lights of different colors into an interior of said bottle for beverages, and control means controlling said light emitting means so that said light emitting means emit lights of corresponding colors selectively.

In accordance with another feature of the present invention, said control means is configured to control said light emitting means so that said light emitting means emit lights of different colors continuously in an alternating order.

In accordance with a further feature of the present invention said element with said display has a predetermined color, said control means being configured to control said light emitting means so that said light emitting means emit light of a color corresponding to said color of said element with said display.

A further feature of the present invention resides in that said display displays video images of a predetermined color, said control means being configured to control said light emitting means so that said light emitting means emit light of a color corresponding to the color of said video images displayed by said display.

Another feature of the present invention resides in the system wherein said control means is configured so that it is pre-programmable and thereby said emitting of lights of corresponding colors selectively is performed automatically.

In accordance with another feature of the present invention, said control means is actuatable by a user so that the user can control said light emitting means to emit lights of corresponding colors selectively.

Finally in accordance with the invention said element with said electronic display is removable and replaceable by another new element with said electronic display having different color, said control means being configured to control said light emitting means so that said light emit light of a color corresponding to the color of said new element with said electronic display.

The novel features of the present invention are set forth in particular in the appended claims. The invention itself however, both as to its construction and its manner of operation, will be best understood from the description of preferred embodiments, which is accompanied by the following drawings.

### BRIEF DESCRIPTION OF THE DRAWINGS

FIG. 1 is a view showing a system including a bottle for beverages and a stand for supporting the bottle, in accordance with the present invention; and

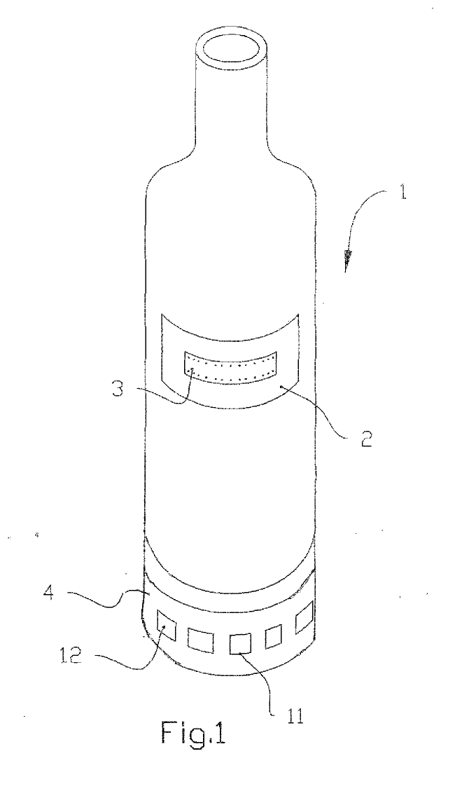

FIG. 2 is a plan view of the stand of the system in accordance with the present invention, with the bottle for beverages removed.

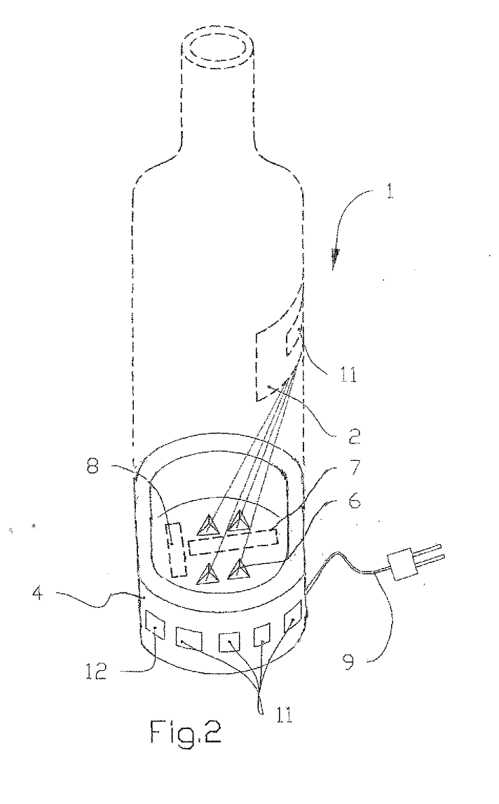

### DESCRIPTION OF THE PREFERRED EMBODIMENTS

A system in accordance with the present application has a bottle for beverages which is identified with reference numeral 1 and is provided with an element 2 having a display, and can be removable inserted into a cavity in a wall of the bottle, as disclosed for example in our patent application Ser. No. 11/588,494 filed on Oct. 28,2006, which is incorporated here by reference.

The electronic display of the bottle for beverages displays video images of different type, including letters, numbers, symbols, producing informative, advertising, proprietary and other video messages.

The elements 2 with the display 3 are interchangeable and can have different colors. The video images displayed on the display 3 can be also different colors.

The system further has a stand 4 which is provided with a receptacle 5 that can receive a lower part of the bottle 1 and thereby support the bottle. The stand 4 has light emitting means 6 which can emit different colors and can be formed for example as LEDs of different colors: red, blue, yellow etc.

The stand 4 further has corresponding electronic means, such as including a microprocessor 7, batteries 8, electric cable 9. The stand further has control means 10 for controlling the operation of the light emitting means 6 of the stand 4. The control means can includes control buttons or a keyboard. The buttons can include buttons 11 which when pressed operated the light emitting diodes of corresponding colors, and an on/off button 12.

The inventive system operates in the following manner.

It can be preprogrammed that the light emitting diodes are activated in a predetermined sequence, and therefore when a user presses the button 12 the diodes operated in the predetermined sequence to emit consecutively red light, green light, yellow light etc. in a continuous or intermittent manner. On the other hand, a user by acting on buttons 11 can provide emitting of only one light, or any combination lights as he/she wishes.

The colors of lights can be selected to correspond to the color of the element 2 or to the color of the images displayed by the display 3.

In accordance with a very important feature of the present invention, the light emitting means or the LED's 6 are oriented so that the light emitted by them is directed exactly towards the element 2, which can be also transparent, and exactly towards the electronic display 3, thus providing a special interacting of the light emitted by the light emitting means of stand with the element 2 and the electronic display 3.

The invention is not limited to the details shown since various changes can be made without departing from the spirit of the present invention.

What is desired to be protected by letters patent is set forth in particular in the appended claims.

1. A system, comprising a bottle for beverages having an element with an electronic display displaying video images; and a stand for supporting said bottle for beverages, said stand having a receptacle which is configured for receiving a part of said bottle for beverages and thereby supporting the latter, said stand also having light emitting means configured to emit lights of different colors into an interior of said bottle for beverages, and control means controlling said light emitting means so that said light emitting means emit lights of corresponding colors selectively.

2. A system as defined in claim 1, wherein said control means is configured to control said light emitting means so that said light emitting means emit lights of different colors continuously in an alternating order.

3. A system as defined in claim 1, wherein said element with said display has a predetermined color, said control means being configured to control said light emitting means so that said light emitting means emit light of a color corresponding to said color of said element with said display.

4. A system as defined in claim 1, wherein said display displays videoimages of a predetermined color, said control means being configured to control said light emitting means so that said light emitting means emit light of a color corresponding to the color of said video images displayed by said display.

5. A system as defined in claim 1, wherein said control means is configured so that it is pre-programmable and thereby said emitting of lights of corresponding colors selectively is performed automatically.

6. A system as defined in claim 1, wherein said control means is actuatable by a user which thereby can control said light emitting means to emit lights of corresponding colors selectively.

7. A system as defined in claim 1, wherein said element with said electronic display is removable and replaceable by another new element with said electronic display having different color, said control means being configured to control said light emitting means so that said light emit light of a color corresponding to the color of said new element with said electronic display.

8. A system as defined in claim 1, wherein said light emitting means is oriented so that light emitted by said light emitting means of said stand is directed towards said element and said electronic display of said bottle for beverages.
